(19) United States
(12) Patent Application Publication
(10) Pub. No.: US 2026/0298684 A1
(43) Pub. Date: Oct. 1, 2026

(54) SYSTEMS AND METHODS FOR DETECTING DEPOSIT ACCUMULATION WITHIN A MULTIPHASE FLOW METER

(71) Applicant: Schlumberger Technology Corporation, Sugar Land, TX (US)

(72) Inventors: Tianjun Hou, Clamart (FR); Xiqing Chang, Clamart (FR); Bertrand Claude Theuveny, Paris (FR); Jean-Philippe Hussenet, Saint-Prix (FR); Katharine Moncada, Houston, TX (US)

(21) Appl. No.: 19/091,896

(22) Filed: Mar. 27, 2025

(51) Int. Cl. G01F 15/063; G01F 1/34

(52) U.S. Cl. CPC G01F 15/063; G01F 1/34

(57) ABSTRACT

A multiphase flow meter comprising a venturi channel through a multiphase stream of fluid is enabled to flow, a multivariable transmitter adapted to measure a pressure differential across the venturi channel, and a controller adapted to a plurality of measurements indicative of a pressure differential across the venturi channel during a first period of time, determine a baseline value for a statistical characteristic associated with pressure differential across the venturi channel, receive a new measurement indicative of pressure differential across the venturi channel after the first period of time, a new value for the statistical characteristic associated with pressure differential across the venturi channel, determine whether a difference between the baseline value and the new value exceeds a threshold, and responsive to determining that the difference between the baseline value and the new value exceeds the threshold, generate an alert that indicative of deposit accumulation in the multiphase flow meter.

### FIELD

The present disclosure relates to flow meters, and more specifically, detecting deposit accumulation within a multiphase flow meter.

### BACKGROUND

Multiphase flow meters (MPFMs) can be used in a variety of industries to measure the respective flow rates of multiple fluids flowing through a single conduit (e.g., a pipe). For example, a multiphase flow meter can be used in the oil and gas industry to measure the respective flow rates of oil, water, and gas in a single multiphase stream flowing through a pipe. In addition to measuring fluid flow rate, a multiphase flow meter can be used to measure other parameters associated with a fluid such as, but not limited to, temperature, pressure, density and viscosity, and/or energy attenuation.

During oil production processes, knowledge of the individual flow rates of oil, water, and gas in a multiphase stream of fluid flowing from a well is necessary for making production and/or control decisions associated with reservoir management, field development, operational control, and/or production allocation. In that regard, it is important for a multiphase flow meter to measure these respective fluid flow rates accurately and reliably.

However, during use of a multiphase flow meter within an oil production environment, sediment deposits can accumulate within and degrade the performance of the multiphase flow meter. For example, the accumulation of sediment deposits, such as wax deposits and/or scale deposits, within portions of the multiphase flow meter may cause the accuracy reduce the accuracy with the which the multiphase flow meter measures fluid flow rate and/or other parameters associated with a fluid (e.g., temperature, differential pressure, density, viscosity, gamma-ray absorption, and/or energy attenuation). Accordingly, to maintain accurate and reliable operation of a multiphase flow meter, it is helpful to detect deposit accumulation within the multiphase flow meter.

Over the years, various approaches to detecting deposit accumulation within a flow meter have been developed. In one commonly used approach, deposit accumulation within a flow meter is determined manually by a domain expert and/or field personnel. For example, in this approach, a domain expert manually analyzes the data generated by a flow meter (e.g., flow rate data, temperature data, pressure data, etc.) to determine, based on the data, whether there is deposit accumulation affecting the performance of the flow meter. At least one drawback to this approach, however, is that experience levels among the domain experts tasked with analyzing the data can vary greatly thereby resulting in inconsistent detection of deposit accumulation. Moreover, with this approach, deposit accumulation is often detected too late such that inaccuracies in the measurements generated by the flow meter may persist for extended periods of time (e.g., days, weeks, months, etc.).

In another commonly used approach, field technicians inspect and calibrate flow meters on a regular basis to detect the presence of and/or mitigate the effect of deposit accumulation within the flow meters. However, this approach consumes significant amounts of time and resources. For example, this approach often results in technicians traveling to and inspecting flow meters that do not require any attention (e.g., do not contain significant amounts of deposit accumulation). Moreover, this approach also suffers from the problem of detecting deposit accumulation within a flow meter too late.

As the foregoing illustrates, what is needed in the art are more effective techniques for detecting deposit accumulation within multiphase flow meters.

### SUMMARY

In one independent aspect, a multiphase flow meter comprising a venturi channel through a multiphase stream of fluid is enabled to flow, a multivariable transmitter adapted to measure a pressure differential across the venturi channel, and a controller coupled to the multivariable transmitter. The controller is adapted to receive, from the multivariable transmitter, a plurality of measurements indicative of a pressure differential across the venturi channel during a first period of time, determine, based on the first plurality of measurements, a baseline value for a statistical characteristic associated with pressure differential across the venturi channel, receive, from the multivariable transmitter, a new measurement indicative of pressure differential across the venturi channel after the first period of time, determine, based in part on the new measurement, a new value for the statistical characteristic associated with pressure differential across the venturi channel, determine whether a difference between the baseline value and the new value exceeds a threshold, and in response to determining that the difference between the baseline value and the new value exceeds the threshold, generate an alert that indicates there is deposit accumulation within the multiphase flow meter.

In another independent aspect, a method for detecting deposit accumulation within a multiphase flow meter, the method comprising receiving, from the multivariable transmitter, a plurality of measurements indicative of pressure differential across the venturi channel during a first period of time, determining, based on the first plurality of measurements, a baseline value for a statistical characteristic associated with pressure differential across the venturi channel, receiving, from the multivariable transmitter, a new measurement indicative of pressure differential across the venturi channel after the first period of time, determining, based in part on the new measurement, a new value for the statistical characteristic associated with pressure differential across the venturi channel, determining whether a difference between the baseline value and the new value exceeds a threshold, and in response to determining that the difference between the baseline value and the new value exceeds the threshold, generating an alert that indicates there is deposit accumulation within the multiphase flow meter.

In another independent aspect, a wellsite comprising an oil well adapted to produce a multiphase stream of fluid, a manifold coupled to the oil well, the manifold adapted to direct the multiphase stream of fluid to one or more components of the wellsite, and a multiphase flow meter coupled to the manifold. The multiphase flow meter includes a venturi channel through a multiphase stream of fluid is enabled to flow, a multivariable transmitter adapted to measure a pressure differential across the venturi channel, and a controller coupled to the multivariable transmitter. The controller is adapted to receive, from the multivariable transmitter, a plurality of measurements indicative of a pressure differential across the venturi channel during a first period of time, determine, based on the first plurality of measurements, a baseline value for a statistical characteristic associated with pressure differential across the venturi channel, receive, from the multivariable transmitter, a new measurement indicative of pressure differential across the venturi channel after the first period of time, determine, based in part on the new measurement, a new value for the statistical characteristic associated with pressure differential across the venturi channel, determine whether a difference between the baseline value and the new value exceeds a threshold, and in response to determining that the difference between the baseline value and the new value exceeds the threshold, generate an alert that indicates there is deposit accumulation within the multiphase flow meter.

Other aspects will become apparent by consideration of the detailed description and accompanying drawings.

At least one technical advantage of the disclosed techniques relative to conventional approaches is that deposit accumulation can be detected automatically without relying on manual analysis of data by domain experts and/or physical visits to multiphase flow meters installed at a wellsite by field technicians. In that regard, with the disclosed techniques, deposit accumulation within a multiphase flow meter can be detected more accurately, with higher consistency, and with fewer resources (e.g., manpower) than conventional approaches.

### BRIEF DESCRIPTION OF THE DRAWINGS

FIG. 1 illustrates an example wellsite at which a multiphase flow meter is implemented, according to aspects of the various embodiments.

FIG. 2 is a frontal view of the multiphase flow meter of FIG. 1, according to various embodiments.

FIG. 3 is a frontal cross-section view of the multiphase flow meter of FIG. 1, according to various embodiments.

FIG. 4 is a perspective cross-section view of the multiphase flow meter of FIG. 1, according to various embodiments.

FIG. 5 is a block diagram of a controller included in the multiphase flow meter of FIG. 1, according to various embodiments.

FIG. 6 illustrates an example plot of DPV measurements categorized according to a moving average statistical method, according to various embodiments.

FIG. 7 illustrates an example plot of DPV measurements categorized according to a local outlier factor method, according to various embodiments.

FIG. 8 is a flow diagram of method steps for detecting deposit accumulation within a multiphase flow meter, according to various embodiments.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more electronic processors, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

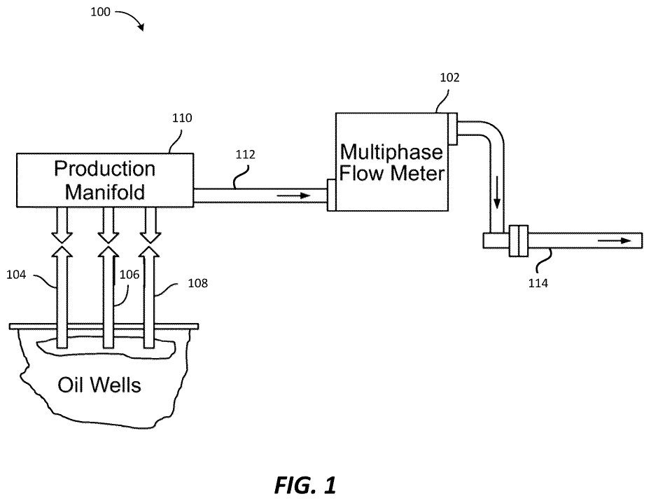

FIG. 1 illustrates an example wellsite 100 at which a multiphase flow meter 102 is implemented, according to aspects of the various embodiments. In the illustrated example of FIG. 1, the wellsite 100 includes a first oil well 104, a second oil well 106, and a third oil well 108. However, in other examples, the wellsite 100 can include a different number of oil wells (e.g., fewer than three or more than three). As shown, the oil wells 104, 106, and 108 are coupled to a production manifold 110 such that respective multiphase streams of fluid containing gas, oil, and water flow from each of the oil wells 104, 106, and 108 into the production manifold 110. In some examples, such as in the illustrated example of FIG. 1, the oil wells 104, 106, and 108 are individually coupled to the production manifold 110. In other examples, the oil wells 104, 106, and 108 can be coupled to the production manifold 110 together.

The multiphase flow meter 102 is coupled to an outlet of the production manifold 110 via one or more pipes 112. In that regard, the production manifold 110 directs, via the one or more pipes 112, a multiphase stream of fluid output by one or more of the oil wells 104, 106, and 108 to the multiphase flowmeter 102. As a multiphase stream of fluid flows through the multiphase flow meter 102, the multiphase flow meter 102 can determine respective flow rates of the oil, gas, and water included in the multiphase stream of fluid. In some examples, the multiphase flow meter 102 also determines one or more of a temperature, a pressure, a density, a viscosity, and/or an energy attenuation associated with the multiphase stream of fluid. The multiphase stream of fluid then exits the multiphase flow meter 102 via one or more pipes 114. The one or more pipes 114 can, for example, direct the multiphase stream of fluid to a production line, storage tanks, a disposal line, or some other location.

In the illustrated example of FIG. 1, only one multiphase flow meter 102 is shown to be implemented at the wellsite 100. However, in some examples, more than one (e.g., two, three, five, ten, etc.) multiphase flow meters 102 can be implemented at the wellsite 100. In such examples, multiple multiphase flow meters 102 can be connected to respective outlets of the production manifold 110 via one or more pipes 112 such that each multiphase flow meter 102 receives a respective multiphase stream of fluid from the production manifold 110.

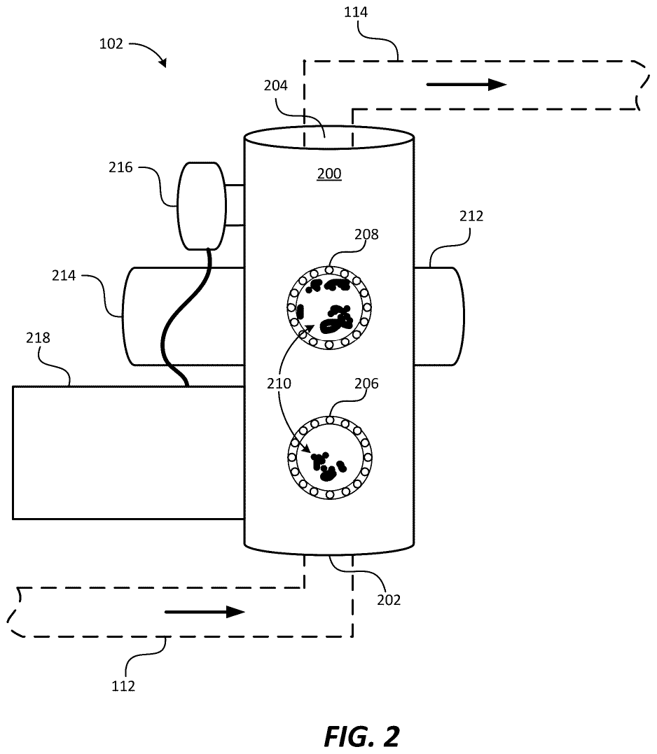

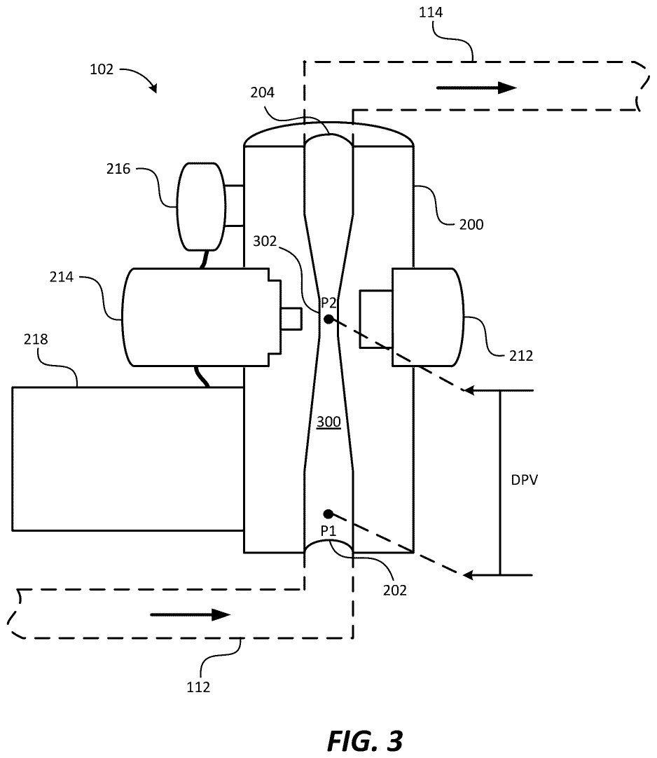

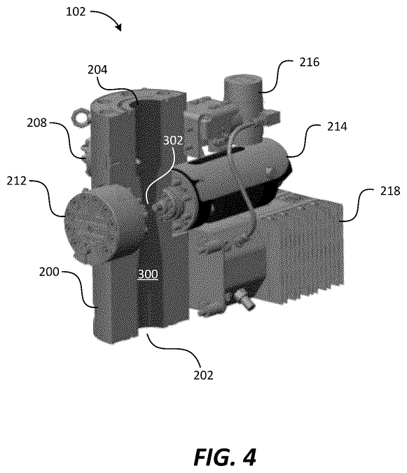

FIG. 2 is a frontal view of the multiphase flow meter 102, according to various embodiments. As shown, the multiphase flow meter 102 includes a venturi 200 through which a multiphase stream of fluid can flow. For example, a multiphase stream of fluid can flow from an inlet pipe 112 into the venturi 200 via an inlet 202 and out of the venturi 200 into an outlet pipe 114 via an outlet 204. As shown in FIGS. 3 and 4, the interior of the venturi 200 defines a channel 300 through which the multiphase stream of fluid flows. The channel 300 has, for example, an hourglass shape in which the diameter of the throat 302 of the channel 300 is narrower than the respective diameters of the inlet 202 to the channel 300 and the outlet of the channel 300.

As further shown in FIG. 2, a first pressure tapping port 206 and a second pressure tapping port 208 are disposed on an exterior surface of the venturi 200. The first pressure tapping port 206 is disposed closer to the inlet 202 of the venturi 200 and the second pressure tapping port 208 is disposed near the center of the venturi 200 (e.g., near the throat 302 of the channel 300). Moreover, the first and second pressure tapping ports 206, 208 are disposed coaxially along a direction through which a multiphase stream of fluid flows through the venturi 200.

Each of the first and second pressure tapping ports 206, 208 provide mechanisms through which pressure within the interior of the venturi 200 (e.g., pressure in the channel 300) can be measured. For example, the first pressure tapping port 206 comprises a pressure sealing membrane and/or one or more ports through which a sensor (e.g., a pressure sensor) can sense pressure near the inlet 202 to the channel 300. In that regard, the first pressure tapping port 206 can be used to measure the pressure of the multiphase stream of fluid flowing through the inlet 202 to the channel 300. As another example, the second pressure tapping port 208 comprises a pressure sealing membrane and/or one or more ports through which a sensor (e.g., a pressure sensor) can sense pressure within the throat 302 of the channel 300. In that regard, the second pressure tapping port 208 can be used to measure the pressure of the multiphase stream of fluid flowing through the throat 302 of the channel 300.

As described herein, sediment deposits (e.g., wax deposits, scale deposits, etc.) can accumulate within and degrade the performance of the multiphase flow meter 102. In the illustrated example of FIG. 2, sediment deposits, or deposits, 210 have accumulated within the respective membranes of the first and second pressure tapping ports 206, 208. Thus, in the illustrated example of FIG. 2, the accuracy of pressure measurements taken through the first and second pressure tapping ports 206, 208 may be decreased as a result of the accumulation of deposits 210. Moreover, in the illustrated example of FIG. 2, the accumulation of deposits 210 within membranes of the first and second pressure tapping ports 206, 208 indicates that there could be deposit accumulation within other portions of the multiphase flow meter 102 that is reducing the accuracy of other measurements (e.g., flow rate measurements, temperature measurements, density measurements, viscosity measurements, gamma-ray absorption measurements, and/or energy attenuation measurements) generated by the multiphase flow meter 102.

As further shown in FIG. 2, the multiphase flow meter 102 includes a radioactive source 212, a nuclear detector 214, a multivariable transmitter 216, and a controller 218. In some examples, the radioactive source 212 is implemented using a gamma source such as Barium 133. The nuclear detector 214 is adapted to sense one or more nuclear properties, such as gamma-ray absorption, of the multiphase stream of fluid flowing through the venturi 200.

The multivariable transmitter 216 is adapted to measure, or sense, one or more properties of the multiphase stream of fluid flowing through the channel 300 of the venturi 200. For example, the multivariable transmitter 216 can sense the pressure of the multiphase stream of fluid at one or more points within the channel 300, a temperature of the multiphase stream of fluid at one or more points within the channel 300, and/or one or more other properties of the multiphase stream of fluid flowing through the channel 300.

In some examples, the multivariable transmitter 216 is adapted to generate a measurement of a differential pressure across the venturi 200. A measurement of a differential pressure across the venturi 200, which can hereinafter be referred to as a “DPV measurement,” is indicative of a pressure difference between the inlet 202 to the channel 300 and the throat 302 of the channel 300. In that regard, as a multiphase stream of fluid flows through the channel 300, the multivariable transmitter 216 can generate DPV measurements indicative of a difference between the pressure of the multiphase stream of fluid flowing through the inlet 202 and the pressure of the multiphase stream of fluid flowing through the throat 302.

FIG. 3 is a frontal cross-section view of the multiphase flow meter 102 and FIG. 4 is a perspective cross-section view of the multiphase flow meter 102, according to various embodiments. With respect to FIG. 3, the multivariable transmitter 216 can generate a DPV measurement that is indicative of a difference between the pressure P1 of the multiphase stream of fluid flowing through the inlet 202 to the channel 300 and the pressure P2 of the multiphase stream of fluid flowing through the throat 302 of the channel 300. For example, the multivariable transmitter 216 generates the DPV measurement by sensing the pressure P1, sensing the pressure P2, and determining a difference between the pressures P1, P2. In some examples, the multivariable transmitter 216 can use the first and second pressure tapping ports 206, 208 to generate the DPV measurement. For example, the multivariable transmitter 216 can use a first pressure sensor to sense, via the first pressure tapping port 206, the pressure P1 of the multiphase stream of fluid flowing through the inlet 202. Moreover, the multivariable transmitter 216 can use a second pressure sensor to sense, via the second pressure tapping port 208, the pressure P2 of the multiphase stream of fluid flowing through the throat 302.

As will be described in more detail herein, the controller 218 is adapted to detect the presence of deposit accumulation within the multiphase flow meter 102. For example, the controller 218 can implement one or more statistical methods to determine whether deposit accumulation within the multiphase flow meter 102 is present based in part on DPV measurements generated by the multivariable transmitter 216.

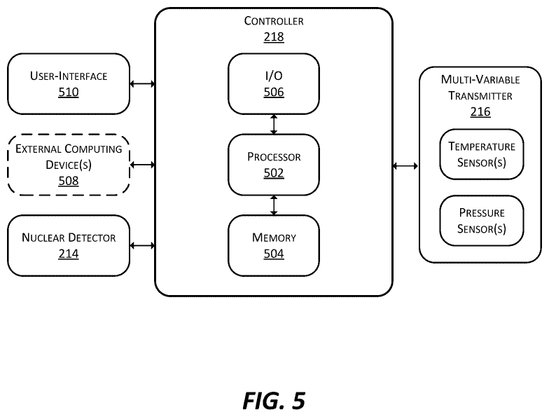

FIG. 5 is a block diagram of the controller 218 included in the multiphase flow meter 102, according to various embodiments. As shown in the illustrated example of FIG. 5, the controller 218 is coupled to and/or controls operation of various components included in the multiphase flow meter 102. For example, the controller 218 is coupled to the nuclear detector 214 and the multivariable transmitter 216, which includes one or more temperature sensors and/or one or more pressure sensors as described herein. In some examples, the controller 218 is coupled to the nuclear detector 214 and/or the multivariable transmitter 216 via one or more wireless connections. In other examples, the controller 218 is coupled to the nuclear detector 214 and/or the multivariable transmitter 216 using one or more wired connections.

As further shown in the illustrated example of FIG. 5, the controller 218 includes a processor 502 (e.g., a microprocessor, a microcontroller, or another suitable programmable device), a memory 504, and an input/output (“I/O”) system 506 that are interconnected by a bus. In some examples, the controller 218 can be implemented as a computing device such as, but not limited to, a special purpose computing device, a general purpose computing device, a laptop computer, a smartphone, a desktop computer, a server, a tablet, cloud-based computing device, or some other suitable type of computing device.

The I/O system 506 includes routines for transferring information between components within the controller 218 and other components of the multiphase flow meter 102. In some examples, the I/O system 506 includes a communication interface that is configured to provide communication between the controller 218 and one or more external computing devices 508 (e.g., a smart phone, a tablet, a laptop, etc.). In some examples, the I/O system 506 enables the controller 218 to communicate with external computing devices 508 associated with operators of the wellsite 100 at which the multiphase flow meter 102 is implemented.

In some examples, the controller 218 communicates with the one or more external computing devices 508 through a network. The network is, for example, a wide area network (WAN) (e.g., the Internet, a TCP/IP based network, a cellular network, such as, for example, a Global System for Mobile Communications [GSM] network, a General Packet Radio Services [GPRS] network, a Code Division Multiple Access [CDMA] network, an Evolution-Data Optimized [EV-DO] network, an Enhanced Data Rates for GSM Evolution [EDGE] network, a 3 GSM network, a 4GSM network, a Digital Enhanced Cordless Telecommunications [DECT] network, a Digital AMPS [IS-136/TDMA] network, or an Integrated Digital Enhanced Network [iDEN] network, etc.). In other examples, the network is, for example, a local area network (LAN), a neighborhood area network (NAN), a home area network (HAN), or personal area network (PAN) employing any of a variety of communications protocols, such as Wi-Fi, Bluetooth, ZigBee, etc. In some examples, the network includes one or more of a wide area network (WAN), a local area network (LAN), a neighborhood area network (NAN), a home area network (HAN), or personal area network (PAN).

In some examples, the I/O system 506 further includes and/or is coupled to a user-interface 510. The user-interface 510 is adapted to receive input from an operator of the wellsite 100 at which the multiphase flow meter 102 is implemented and/or output information to an operator of the wellsite 100 at which the multiphase flow meter 102 is implemented. For example, the user-interface 510 can output information indicative of deposit accumulation detected within the multiphase flow meter 102. In some examples, the user-interface 510 includes a display (e.g., a primary display, a secondary display, etc.) and/or input devices (e.g., touchscreen displays, a plurality of knobs, dials, switches, buttons, levers, joysticks, etc.). The display may be, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, etc. In some examples, the user-interface 510 includes one or more audio indicators (e.g., speakers, horns, buzzers, etc.) and/or visual indicators such as LEDs.

The memory 504 includes, for example, a read-only memory (“ROM”), a random access memory (“RAM”), an electrically erasable programmable read-only memory (“EEPROM”), a flash memory, a hard disk, an SD card, or another suitable magnetic, optical, physical, or electronic memory device. The memory 504 stores software, such as but not limited to firmware, one or more applications, program data, one or more program modules, and/or other executable instructions, for detecting the deposit accumulation within the multiphase flow meter 102. In some examples, the memory 504 stores data comprising DPV measurements generated by the multivariable transmitter 216. In some examples, the memory 504 stores one or more threshold values for determining whether deposit accumulation is present within the multiphase flow meter 102.

In operation, the processor 502 retrieves from the memory 504 and executes software instructions for detecting the presence of deposit accumulation within the multiphase flow meter 102. Hereinafter, functions and/or actions performed by components of the controller 218 (e.g., processor 502, memory 504, and I/O system 506) can collectively be referred to as being performed by the controller 218. In that regard, the controller 218 executes software instructions for detecting the presence of deposit accumulation within the multiphase flow meter 102.

As described herein, deposit accumulation within the multiphase flow meter 102 can affect the accuracy of measurements generated by the multiphase flow meter 102 (e.g., DPV measurements generated by the multivariable transmitter 216). In that regard, before the controller 218 can effectively determine whether deposit accumulation is impacting the performance of the multiphase flow meter 102, a baseline for performance of the multiphase flow meter 102 in the absence of deposit accumulation must be established for comparison. As will be described in more detail herein, the controller 218 can compare performance of the multiphase flow meter 102 under normal operating conditions to the established baseline for performance for the multiphase flow meter 102 to determine whether there is deposit accumulation within the multiphase flow meter 102. For example, when there is significant deviation between performance of the multiphase flow meter 102 under normal operating conditions and the established baseline for performance of the multiphase flow meter 102, the controller 218 determines that there is deposit accumulation within the multiphase flow meter 102.

In response to determining that there is deposit accumulation within the multiphase flow meter 102, the controller 218 generates one or more alerts that indicate deposit accumulation within the multiphase flow meter 102. In some examples, generating an alert indicative of deposit accumulation within the multiphase flow meter 102 includes transmitting the alert to one or more external computing devices 508 associated with operators of the wellsite 100. In some examples, generating an alert indicative of deposit accumulation within the multiphase flow meter 102 includes activating one or more indicators (e.g., display, visual indicators, audible indicators, etc.) included in the user-interface 510. In some examples, the alert includes a recommended action for mitigating the effects of the deposit accumulation within the multiphase flow meter 102. For example, the alert includes a recommendation for cleaning and/or servicing the multiphase flow meter 102. In some examples, a recommendation for cleaning and/or servicing the multiphase flow meter 102 can include, without limitation, a type of chemical and/or solution that can be used to clean the deposit accumulation or a recommended schedule for cleaning and/or servicing the multiphase flow meter 102.

In some examples, the baseline for performance of the multiphase flow meter 102 in the absence of deposit accumulation is established by the controller 218. In such examples, the controller 218 can establish the baseline based on DPV measurements generated by the multivariable transmitter 216 in the absence of deposit accumulation within the multiphase flow meter 102. For example, the controller 218 determines a baseline value and/or range of values for DPV measurements generated by the multivariable transmitter 216 when there is no deposit accumulation within the multiphase flow meter 102. Then, during operation of the multiphase flow meter 102 under normal operating conditions, the controller 218 can compare new DPV measurements generated by the multivariable transmitter 216 to the established baseline value and/or range of values for DPV measurements to determine whether deposit accumulation is present within the multiphase flow meter 102. When new DPV measurements deviate from the established baseline value and/or range of values for DPV measurements by more than a threshold amount, the controller 218 determines that there is deposit accumulation within the multiphase flow meter 102. In response to determining that deposit accumulation is present within the multiphase flow meter 102, the controller 218 generates one or more alerts that indicate the deposit accumulation within the multiphase flow meter 102 as described herein.

In some examples, the baseline for performance of the multiphase flow meter 102 is not a fixed value or set of values. Rather, the baseline for performance of the multiphase flowmeter 102 can be a dynamic value and/or set of values that is adjusted over time as new DPV measurements are generated by the multivariable transmitter 216. For example, the controller 218 can periodically (e.g., by the minute, hourly, daily, weekly, etc.) or continuously update the baseline for performance of the multiphase flow meter 216 using updated DPV measurements generated by the multivariable transmitter 216. In some examples, the controller 218 calculates a move baseline for performance of the multiphase flow meter 216 by averaging the DPV measurements contained in a sliding time window. In such examples, the sliding time window can include the most recent DPV measurements generated by the multivariable transmitter 216 within the past hour, the past day, the past week, etc.

As described above, when new DPV measurements deviate from the established baseline value and/or range of values for DPV measurements by more than a threshold amount, the controller 218 determines that there is deposit accumulation within the multiphase flow meter 102. In some examples, the controller 218 defines the threshold amount by which new DPV measurements can deviate from the established baseline value(s). In some examples, the controller 218 defines multiple threshold amounts that differ in severity level. For example, the controller 218 can define a first threshold amount associated with minor deposit accumulation within the multiphase flow meter 102, a second threshold amount associated with moderate deposit accumulation within the multiphase flow meter 102, and a third threshold amount associated with severe, or major, deposit accumulation within the multiphase flow meter 102. When new DPV measurements deviate from the established baseline value and/or range of values for DPV measurements by more than the first threshold amount but less than the second threshold amount, the controller 218 generates one or more alerts that indicate the occurrence of minor deposit accumulation within the multiphase flow meter 102. When new DPV measurements deviate from the established baseline value and/or range of values for DPV measurements by more than the second threshold amount but less than the third threshold amount, the controller 218 generates one or more alerts that indicate the occurrence of moderate deposit accumulation within the multiphase flow meter 102. When new DPV measurements deviate from the established baseline value and/or range of values for DPV measurements by more than the third threshold amount, the controller 218 generates one or more alerts that indicate the occurrence of major deposit accumulation within the multiphase flow meter 102.

In some instances, determining whether there is deposit accumulation within the multiphase flow meter 102 based on a direct comparison between new DPV measurements and an established baseline value and/or range of values for DPV measurements may result in alerts being generated even when there is no deposit accumulation within the multiphase flow meter 102. For example, naturally occurring fluctuations in new DPV measurements generated by the multivariable transmitter 216 may deviate from the established baseline value and/or range of values by more than an acceptable threshold even when there is not significant deposit accumulation within the multiphase flow meter 102. To help mitigate the occurrence of generating alerts when there is little to no deposit accumulation within the multiphase flow meter 102, in some examples, one or more statistical analysis methods can be used to analyze DPV measurements and determine whether there is deposit accumulation within the multiphase flow meter 102. By using statistical analysis methods to analyze the DPV measurements, the controller 218 can make determinations regarding deposit accumulation based on trends in the DPV measurements generated by the multivariable transmitter 216 as opposed to individual DPM measurements which may be prone to fluctuate.

### Moving Average

In a first example in which statistical analysis is used to analyze DPV measurements, the controller 218 leverages moving average calculations to determine whether deposits have accumulated within the multiphase flow meter 102. In this example, the controller 218 uses a moving average and/or an average calculation to establish the baseline for performance of the multiphase flow meter 102 in the absence of deposit. For example, the controller 218 establishes a baseline average for DPV measurements generated by the multivariable transmitter 216 when there is little to no deposit accumulation within the multiphase flow meter 102. Hereinafter, a baseline average for DPV measurements generated by the multivariable transmitter 216 can be referred to as the “baseline DPV average” or “baseline DPV moving average.”

In some examples, the controller 218 uses Equation 1 below to establish the baseline DPV average. In such examples, the baseline DPV average can be determined within a time window during which it is known that there is little to no deposit accumulation in the multiphase flow meter 102. In Equation 1, MAₜ is the moving average of DPV measurements generated by the multivariable transmitter 216 at time t, DPVₜ₋ᵢ is a DPV measurement data point at time t-i, and n is the number of DPV measurements data points in the window.

$$M {A}_{t} = \frac{1}{n} {\sum }_{i = 1}^{n} {DPV}_{t - i} \qquad Equation 1$$

After the baseline DPV average has been established, the controller 218 calculates and/or updates a moving average for DPV measurements generated by the multivariable transmitter 216 during operation of the multiphase flow meter 102. Hereinafter, the moving average for DPV measurements generated by the multivariable transmitter 216 can be referred to as the “DPV moving average.” For example, the controller 218 uses Equation 1 above to calculate and/or update the DPV moving average. In some examples, the controller 218 calculates a new DPV moving average each time a new DPV measurement is generated by the multivariable transmitter 216. In some examples, the controller 218 calculates a new DPV moving average on a periodic basis (e.g., once per minute, once per 5 minutes, once per 30 minutes, hourly, daily, etc.). In some examples, the controller 218 calculates a new DPV moving average after a predetermined number of DPV measurements (e.g., 5, 10, 50, 100, etc.) have been generated by the multivariable transmitter 216 since the last time a new DPV moving average was calculated. In some examples, the controller 218 calculates a new DPV moving average on an ad-hoc or intermittent basis.

The controller 218 can then compare the new DPV moving average to the baseline DPV average to determine whether there is deposit accumulation within the multiphase flow meter 102. For example, the controller 218 compares a difference between the new DPV moving average and the baseline DPV average to one or more thresholds associated with deposit accumulation within the multiphase flow meter 102. In some examples, the controller 218 determines that there is deposit accumulation within the multiphase flow meter 102 when the difference between the new DPV moving average and the baseline DPV average exceeds a threshold associated with deposit accumulation within the multiphase flow meter 102. In some examples, the controller 218 determines that there is not deposit accumulation within the multiphase flow meter 102 when the difference between the new DPV moving average and the baseline DPV average is less than a threshold associated with deposit accumulation within the multiphase flow meter 102.

In some examples, the controller 218 determines that (i) there is no deposit accumulation within the multiphase flow meter 102 when the difference between the new DPV moving average and the baseline DPV average is less than a first threshold associated with deposit accumulation within the multiphase flow meter 102, (ii) deposit accumulation within the multiphase flow meter 102 is possible when the difference between the new DPV moving average and the baseline DPV average exceeds the first threshold but is less than a second threshold associated with deposit accumulation within the multiphase flow meter 102, and (iii) deposit accumulation within the multiphase flow meter 102 is very likely when the difference between the new DPV moving average and the baseline DPV average exceeds the second threshold.

In some examples, the values for the one or more thresholds associated with deposit accumulation within the multiphase flow meter 102 are determined after the baseline DPV average is determined. In some examples, the values for the one or more thresholds associated with deposit accumulation within the multiphase flow meter 102 are determined based on one or more of historical performance of one or more multiphase flow meters, the type(s) of multiphase streams of fluid flowing through the multiphase flow meter 102, known operating conditions of the wellsite 100, and/or other parameters that impact operation of the multiphase flow meter 102. In some examples, the values for the one or more thresholds associated with deposit accumulation within the multiphase flow meter 102 are determined automatically by the controller 218. In other examples, the values for the one or more thresholds associated with deposit accumulation within the multiphase flow meter 102 are determined manually by a domain expert and/or configured by an operator of the wellsite 100.

In response to determining that there is deposit accumulation within the multiphase flow meter 102 and/or that deposit accumulation within the multiphase flow meter 102 is likely based on the comparison between the new DPV moving average and the baseline DPV average, the controller 218 generates one or more alerts that indicate the occurrence of deposit accumulation within the multiphase flow meter 102. As described herein, in some examples, generating an alert indicative of deposit accumulation within the multiphase flow meter 102 includes transmitting the alert to one or more external computing devices 508 associated with operators of the wellsite 100. In some examples, generating an alert indicative of deposit accumulation within the multiphase flow meter 102 includes activating one or more indicators (e.g., display, visual indicators, audible indicators, etc.) included in the user-interface 510. In some examples, the alert includes a recommended action for mitigating the effects of the deposit accumulation within the multiphase flow meter 102. For example, the alert includes a recommendation for cleaning and/or servicing the multiphase flow meter 102. In some examples, a recommendation for cleaning and/or servicing the multiphase flow meter 102 can include, without limitation, a type of chemical and/or solution that can be used to clean the deposit accumulation or a recommended schedule for cleaning and/or servicing the multiphase flow meter 102.

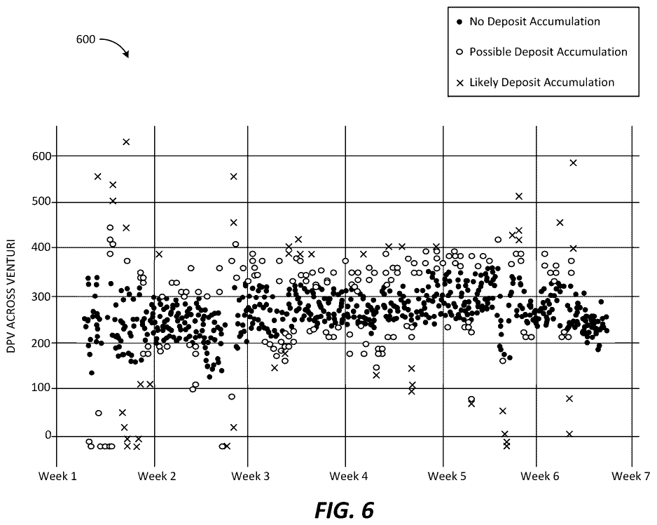

FIG. 6 illustrates an example plot 600 of DPV measurements categorized according to a moving average statistical method, according to various embodiments. In the plot 600, each DPV measurement data point was compared to a baseline DPV average and/or a DPV moving average in accordance with the moving average techniques described herein. For example, the DPV measurement data points in the plot 600 were compared to the baseline DPV average and/or the DPV moving average using one or more thresholds associated with deposit accumulation within the multiphase flow meter 102 as described herein. As shown in FIG. 6, DPV measurement data points indicative of no deposit accumulation within the multiphase flow meter 102 are represented using a solid dot, DPV measurement data points indicative of possible deposit accumulation within the multiphase flow meter 102 are represented using a circle, and DPV measurement data points indicative of likely deposit accumulation within the multiphase flow meter 102 are represented using an X.

### Local Outlier Factor

In a second example in which statistical analysis is used to analyze DPV measurements, the controller 218 leverages local outlier factor (LOF) calculations to determine whether deposits has accumulated within the multiphase flow meter 102. LOF analysis can be used to calculate, or measure, the local density deviation of data points, making it well-suited for detecting outliers such as those caused by deposit accumulation within the multiphase flow meter 102. For example, LOF analysis can be used to calculate an anomaly score for each data point (e.g., DPV measurement) where the anomaly score represents a comparison between the local density of a data point with that of its neighbors (e.g., neighboring DPV measurements).

In this example, the controller 218 first uses one or more LOF calculations to establish the baseline for performance of the multiphase flow meter 102 in the absence of deposit. For example, the controller 218 establishes a baseline LOF for DPV measurements generated by the multivariable transmitter 216 when there is little to no deposit accumulation within the multiphase flow meter 102. Hereinafter, the baseline LOF for DPV measurements generated by the multivariable transmitter 216 can be referred to as the “baseline LOF value.” In some examples, the baseline LOF value is an average of the LOF values for each DPV measurement generated by the multivariable transmitter 216 when there is little to no deposit accumulation within the multiphase flow meter 102. In some examples, the baseline LOV value is an acceptable range of LOV values for DPV measurements.

In some examples, the controller 218 uses Equation 2 below to establish the baseline LOF value. In such examples, the baseline LOF value is an average local outlier probability (LOP) value for DPV measurements or an acceptable range for local outlier probability values for DPV measurements. In Equation 2, LOP(p) is the local outlier probability score for a DPV measurement data point p, Nₚ is the set of neighbors (e.g., neighbor DPV measurements) of the DPV measurement data point p, and density(o) and density(p) are the local densities of DPV measurement data points o and p respectively.

$$L O P ( p ) = \frac{{\sum }_{0 ∈ {N}_{p}} \frac{density ( o )}{density ( p )}}{\vert {N}_{p} \vert} \qquad Equation 2$$

After the baseline LOF value has been established, the controller 218 calculates and/or updates a LOF values for new DPV measurements generated by the multivariable transmitter 216 during operation of the multiphase flow meter 102. For example, the controller 218 uses Equation 2 above to calculate an LOF value (e.g., a local outlier probability) for new DPV measurements generated by the multivariable transmitter 216. In some examples, the controller 218 calculates a new LOF value for each new DPV measurement generated by the multivariable transmitter 216. In some examples, the controller 218 determines a new LOF value that is an average of LOF values calculated for each new DPV measurement generated by the multivariable transmitter 216. For example, the controller 218 determines a new LOF value that is an average of the most recent predetermined number (e.g., 2, 5, 10, 20, 50, etc.) of LOF values calculated for new measurements generated by the multivariable transmitter 216.

The controller 218 can then compare the new LOF value to the baseline LOF value to determine whether there is deposit accumulation within the multiphase flow meter 102. For example, the controller 218 compares a difference between the new LOF value and the baseline LOV value to one or more thresholds associated with deposit accumulation within the multiphase flow meter 102. In some examples, the controller 218 determines that there is deposit accumulation within the multiphase flow meter 102 when the difference between the new LOF value and the baseline LOF value exceeds a threshold associated with deposit accumulation within the multiphase flow meter 102. In some examples, the controller 218 determines that there is not deposit accumulation within the multiphase flow meter 102 when the difference between the new LOF value and the baseline LOF value is less than a threshold associated with deposit accumulation within the multiphase flow meter 102.

In some examples, the controller 218 determines that (i) there is no deposit accumulation within the multiphase flow meter 102 when the difference between the new LOF value and the baseline LOF value is less than a first threshold associated with deposit accumulation within the multiphase flow meter 102, (ii) deposit accumulation within the multiphase flow meter 102 is possible when the difference between the new LOF value and the baseline LOF value exceeds the first threshold but is less than a second threshold associated with deposit accumulation within the multiphase flow meter 102, and (iii) deposit accumulation within the multiphase flow meter 102 is very likely when the difference between the new LOF value and the LOF value exceeds the second threshold.

In some examples, the values for the one or more thresholds associated with deposit accumulation within the multiphase flow meter 102 are determined after the baseline LOF value is determined. In some examples, the values for the one or more thresholds associated with deposit accumulation within the multiphase flow meter 102 are determined based on one or more of historical performance of one or more multiphase flow meters, the type(s) of multiphase streams of fluid flowing through the multiphase flow meter 102, known operating conditions of the wellsite 100, and/or other parameters that impact operation of the multiphase flow meter 102. In some examples, the values for the one or more thresholds associated with deposit accumulation within the multiphase flow meter 102 are determined automatically by the controller 218. In other examples, the values for the one or more thresholds associated with deposit accumulation within the multiphase flow meter 102 are determined manually by a domain expert and/or configured by an operator of the wellsite 100.

In response to determining that there is deposit accumulation within the multiphase flow meter 102 and/or that deposit accumulation within the multiphase flow meter 102 is likely based on the comparison between the new LOF value and the baseline LOF value, the controller 218 generates one or more alerts that indicate the occurrence of deposit accumulation within the multiphase flow meter 102. As described herein, in some examples, generating an alert indicative of deposit accumulation within the multiphase flow meter 102 includes transmitting the alert to one or more external computing devices 508 associated with operators of the wellsite 100. In some examples, generating an alert indicative of deposit accumulation within the multiphase flow meter 102 includes activating one or more indicators (e.g., display, visual indicators, audible indicators, etc.) included in the user-interface 510. In some examples, the alert includes a recommended action for mitigating the effects of the deposit accumulation within the multiphase flow meter 102. For example, the alert includes a recommendation for cleaning and/or servicing the multiphase flow meter 102. In some examples, a recommendation for cleaning and/or servicing the multiphase flow meter 102 can include, without limitation, a type of chemical and/or solution that can be used to clean the deposit accumulation or a recommended schedule for cleaning and/or servicing the multiphase flow meter 102.

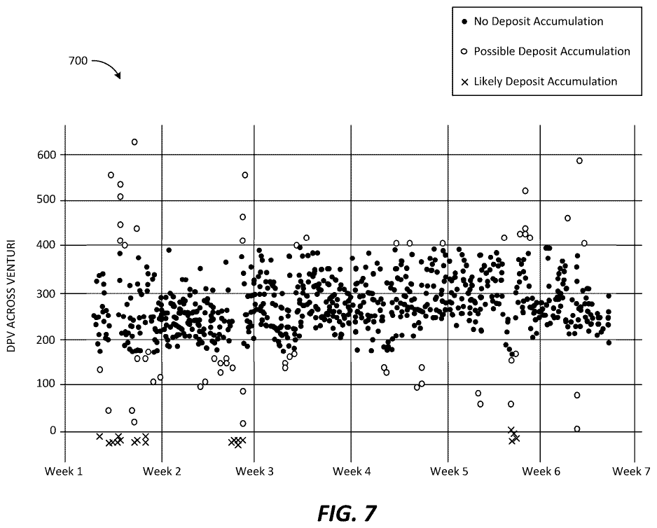

FIG. 7 illustrates an example plot 700 of DPV measurements categorized according to a local outlier factor method, according to various embodiments. In the plot 700, an LOF value calculated for each DPV measurement data point was compared to a baseline LOF value in accordance with the LOF techniques described herein. For example, the respective LOF values of DPV measurement data points in the plot 700 were compared to the baseline LOF value using one or more thresholds associated with deposit accumulation within the multiphase flow meter 102 as described herein. As shown in FIG. 7, DPV measurement data points indicative of no deposit accumulation within the multiphase flow meter 102 are represented using a solid dot, DPV measurement data points indicative of possible deposit accumulation within the multiphase flow meter 102 are represented using a circle, and DPV measurement data points indicative of likely deposit accumulation within the multiphase flow meter 102 are represented using an X.

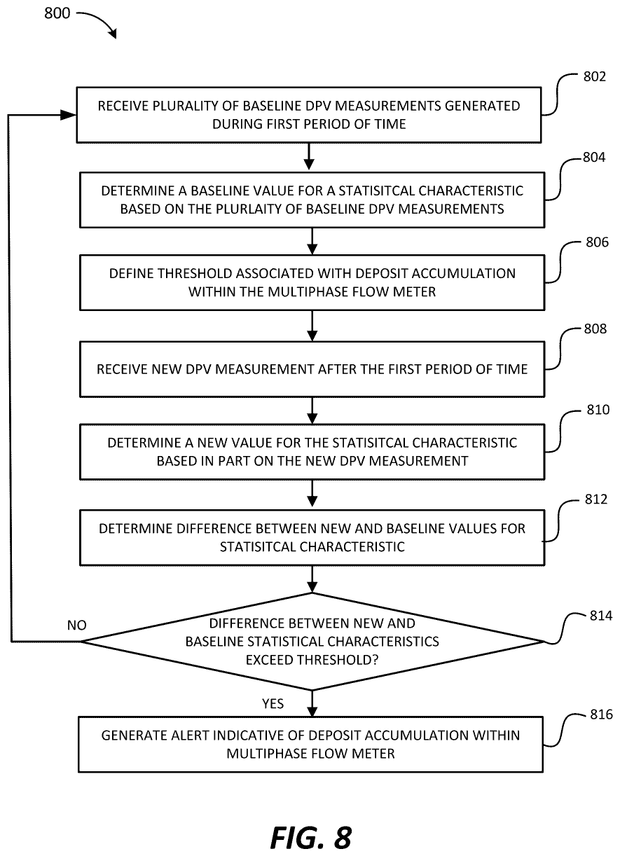

FIG. 8 is a flow diagram of method steps for detecting deposit accumulation within a multiphase flow meter, according to various embodiments. Although the method steps are described in conjunction with the systems of FIGS. 1-7, persons skilled in the art will understand that any system configured to perform the method steps, in any order, is within the scope of the present disclosure.

As shown, a method 800 begins at step 802, at which plurality of measurements indicative of a pressure differential across a venturi channel during a first period of time is received. For example, the controller 218 receives a plurality of DPV measurements generated by the multivariable transmitter 216 during a time period in which there was no deposit accumulation within the multiphase flow meter 102. As another example, the controller 218 continually and/or periodically receives the plurality of DPV measurements during operation of the multiphase flow meter 102.

At step 804, a baseline value for a statistical characteristic associated with a pressure differential across the venturi channel is determined and/or updated based on the plurality of measurements indicative of the pressure differential across the venturi channel. For example, the controller 218 determines a baseline moving average value for a plurality of DPV measurements generated by the multivariable transmitter 216 during a time period in which there was no deposit accumulation within the multiphase flow meter 102. As another example, the controller 218 determines a baseline LOF value for a plurality of DPV measurements generated by the multivariable transmitter 216 during a time period in which there was no deposit accumulation within the multiphase flow meter 102. As described herein, in some examples, the baseline value for the statistical characteristic can be updated over time as new measurements indicative of pressure differential across the venturi channel are generated and/or received.

At step 806, one or more thresholds associated with deposit accumulation within a multiphase flow meter are defined. For example, the controller 218 defines values for one or more thresholds associated with deposit accumulation within the multiphase flow meter 102 based on one or more of historical performance of one or more multiphase flow meters, the type(s) of multiphase streams of fluid flowing through the multiphase flow meter 102, known operating conditions of the wellsite 100, and/or other parameters that impact operation of the multiphase flow meter 102. As described herein, in some examples, a first threshold amount associated with minor deposit accumulation within the multiphase flow meter 102 is defined, a second threshold amount associated with moderate deposit accumulation within the multiphase flow meter 102 is defined, and a third threshold amount associated with severe, or major, deposit accumulation within the multiphase flow meter 102 is defined.

At step 808, a new measurement indicative of a pressure differential across a venturi channel is received after the first period of time. For example, the controller 218 receives a new DPV measurement generated by the multivariable transmitter 216 after the time period in which there was no deposit accumulation within the multiphase flow meter 102.

At step 810, a new value for a statistical characteristic associated with pressure differential across the venturi channel is determined based in part on the new measurement indicative of the pressure differential across the venturi channel. For example, the controller 218 determines a new DPV moving average based in part on a new DPV measurement generated by the multivariable transmitter 216. As another example, the controller 218 determines a new LOF value for the new DPV measurement generated by the multivariable transmitter 216.

At step 812, a difference between the new value for the statistical characteristic and the baseline value for the statistical characteristic is determined. For example, the controller 218 determines a difference between the new value for the statistical characteristic and the baseline value for the statistical characteristic.

At step 814, it is determined whether the difference between the new value for the statistical characteristic and the baseline value for the statistical characteristic exceeds one or more of the thresholds defined at step 806. For example, the controller 218 determines whether the difference exceeds a threshold associated with deposit accumulation within the multiphase flow meter 102.

If, at step 814, it is determined that the difference between the new and baseline values for the statistical characteristic does not exceed the threshold(s) (NO), the method 800 returns to step 802 where new DPV measurements are received and the method 800 is repeated. For example, if the controller 218 determines that the difference between the new and baseline values for the statistical characteristic is less than the threshold(s), the controller 218 receives new DPV measurements at step 802, determines a new baseline value at step 804, defines one or more new thresholds at step 806, and so on.

However, if at step 814, it is determined that the difference between the new and baseline values for the statistical characteristic exceeds one or more of the thresholds (YES), the method 800 proceeds to step 816. For example, if the controller 218 determines that the difference between the new and baseline values for the statistical characteristic exceeds one or more of the threshold(s), the controller 218 determines that deposit accumulation is present within the multiphase flow meter 102 and the method 800 proceeds to step 816.

At step 816, an alert indicative of deposit accumulation within the multiphase flow meter is generated. For example, the controller 218 generates an alert indicative of deposit accumulation within the multiphase flow meter 102. In some examples, the controller 218 transmits the alert to an external computing device 508 associated with an operator of the wellsite 100. In some examples, the controller 218 activates one or more indicators included in the user-interface 510.

For an example in which three thresholds are defined at step 806, the controller 218 can (i) generate an alert indicative of minor deposit accumulation within the multiphase flow meter 102 when the difference between the new and baseline values for the statistical characteristic exceeds the first threshold but is less than the second threshold, (ii) generate an alert indicative of moderate deposit accumulation within the multiphase flow meter 102 when the difference between the new and baseline values for the statistical characteristic exceeds the second threshold but is less than the third threshold, and (iii) generate an alert indicative of major deposit accumulation within the multiphase flow meter 102 when the difference between the new and baseline values for the statistical characteristic exceeds the third threshold.

1. In some embodiments, a multiphase flow meter, comprising a venturi channel through which a multiphase stream of fluid is enabled to flow; a multivariable transmitter adapted to measure a pressure differential across the venturi channel; and a controller coupled to the multivariable transmitter, the controller adapted to receive, from the multivariable transmitter, a plurality of measurements indicative of a pressure differential across the venturi channel during a first period of time; determine, based on the first plurality of measurements, a baseline value for a statistical characteristic associated with pressure differential across the venturi channel; receive, from the multivariable transmitter, a new measurement indicative of a pressure differential across the venturi channel after the first period of time; determine, based in part on the new measurement, a new value for the statistical characteristic associated with pressure differential across the venturi channel; determine whether a difference between the baseline value and the new value exceeds a threshold; and in response to determining that the difference between the baseline value and the new value exceeds the threshold, generate an alert that indicates there is deposit accumulation within the multiphase flow meter.

2. The multiphase flow meter of clause 1, wherein there is no deposit accumulation in the multiphase flow meter during the first period of time.

3. The multiphase flow meter of clauses 1 or 2, wherein the statistical characteristic is a moving average for measurements indicative of pressure differential across the venturi channel.

4. The multiphase flow meter of any of clauses 1-3, wherein the statistical characteristic is a local outlier probability for measurements indicative of pressure differential across the venturi channel.

5. The multiphase flow meter of any of clauses 1-4, wherein the baseline value for the statistical characteristic is an average local outlier probability for the plurality of measurements indicative of the pressure differential across the venturi channel during the first period of time.

6. The multiphase flow meter of any of clauses 1-5, wherein the multivariable transmitter includes a first sensor adapted to sense a pressure of an inlet to the venturi channel and a second sensor adapted to sense a pressure of a throat in the venturi channel; and wherein the pressure differential across the venturi channel is the difference between the pressure of the inlet and the pressure of the throat.

7. The multiphase flow meter of any of clauses 1-6, further comprising a first pressure tapping port disposed on an exterior surface of the venturi channel near the inlet, wherein the first sensor is adapted to sense the pressure of the inlet via the first pressure tapping port; and a second pressure tapping port disposed on the exterior surface of the venturi channel near the throat, wherein the second sensor is adapted to sense the pressure of the throat via the second pressure tapping port.

8. The multiphase flow meter of any of clauses 1-7, wherein the alert includes a recommendation for cleaning the multiphase flow meter.

9. The multiphase flow meter of any of clauses 1-8, wherein the controller is further adapted to transmit the alert to a computing device associated with an operator of a wellsite at which the multiphase flow meter is installed.

10. The multiphase flow meter of any of clauses 1-9, wherein to generate the alert, the controller is further adapted to activate an indicator of the multiphase flow meter.

11. In some embodiments, a method for detecting deposit accumulation within a multiphase flow meter, the method comprising receiving, from a multivariable transmitter, a plurality of measurements indicative of pressure differential across a venturi channel during a first period of time; determining, based on the first plurality of measurements, a baseline value for a statistical characteristic associated with pressure differential across the venturi channel; receiving, from the multivariable transmitter, a new measurement indicative of a pressure differential across the venturi channel after the first period of time; determining, based in part on the new measurement, a new value for the statistical characteristic associated with pressure differential across the venturi channel; determining whether a difference between the baseline value and the new value exceeds a threshold; and in response to determining that the difference between the baseline value and the new value exceeds the threshold, generating an alert that indicates there is deposit accumulation within the multiphase flow meter.

12. The method of clause 11, wherein determining the baseline value for the statistical characteristic associated with pressure differential across the venturi channel includes calculating a moving average for the first plurality of measurements.

13. The method of clauses 11 or 12, wherein determining the new value for the statistical characteristic associated with pressure differential across the venturi channel includes calculating a new moving average based in part on the new measurement and one or more additional measurements indicative of pressure differential across the venturi channel.

14. The method of any of clauses 11-13, wherein determining the baseline value for the statistical characteristic associated with pressure differential across the venturi channel includes calculating an average local outlier probability for the first plurality of measurements.

15. The method of any of clauses 11-14, wherein determining the new value for the statistical characteristic associated with pressure differential across the venturi channel includes calculating a local outlier probability for the new measurement.

16. The method of any of clauses 11-15, further comprising transmitting the alert to a computing device associated with an operator of a wellsite at which the multiphase flow meter is installed.

17. The method of any of clauses 11-16, wherein generating the alert comprises activating at least one of a visual indicator or an audible indicator of the multiphase flow meter.

18. The method of any of clauses 11-17, wherein the alert includes a recommended schedule for servicing the multiphase flow meter.

19. The method of any of clauses 11-18, wherein the alert includes a recommendation for cleaning the multiphase flow meter.

20. In some embodiments, a wellsite comprising an oil well adapted to produce a multiphase stream of fluid; a manifold coupled to the oil well, the manifold adapted to direct the multiphase stream of fluid to one or more components of the wellsite; and a multiphase flow meter coupled to the manifold, the multiphase flow meter comprising a venturi channel through which the multiphase stream of fluid is enabled to flow; a multivariable transmitter adapted to measure a pressure differential across the venturi channel; and a controller coupled to the multivariable transmitter, the controller adapted to receive, from the multivariable transmitter, a plurality of measurements indicative of pressure differential across the venturi channel during a first period of time; determine, based on the first plurality of measurements, a baseline value for a statistical characteristic associated with pressure differential across the venturi channel; receive, from the multivariable transmitter, a new measurement indicative of a pressure differential across the venturi channel after the first period of time; determine, based in part on the new measurement, a new value for the statistical characteristic associated with pressure differential across the venturi channel; determine whether a difference between the baseline value and the new value exceeds a threshold; and in response to determining that the difference between the baseline value and the new value exceeds the threshold, generate an alert that indicates there is deposit accumulation within the multiphase flow meter.

Although certain aspects have been described with reference to certain examples, variations and modifications exist within the spirit and scope of one or more independent aspects. Various features and aspects are set forth in the following claims.

Any and all combinations of any of the claim elements recited in any of the claims and/or any elements described in this application, in any fashion, fall within the contemplated scope of the present disclosure and protection. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A multiphase flow meter, comprising:
a venturi channel through which a multiphase stream of fluid is enabled to flow;
a multivariable transmitter adapted to measure a pressure differential across the venturi channel; and
a controller coupled to the multivariable transmitter, the controller adapted to:
receive, from the multivariable transmitter, a plurality of measurements indicative of a pressure differential across the venturi channel during a first period of time;
determine, based on the first plurality of measurements, a baseline value for a statistical characteristic associated with pressure differential across the venturi channel;
receive, from the multivariable transmitter, a new measurement indicative of a pressure differential across the venturi channel after the first period of time;
determine, based in part on the new measurement, a new value for the statistical characteristic associated with pressure differential across the venturi channel;
determine whether a difference between the baseline value and the new value exceeds a threshold; and
in response to determining that the difference between the baseline value and the new value exceeds the threshold, generate an alert that indicates there is deposit accumulation within the multiphase flow meter.

2. The multiphase flow meter of claim 1, wherein there is no deposit accumulation in the multiphase flow meter during the first period of time.

3. The multiphase flow meter of claim 1, wherein the statistical characteristic is a moving average for measurements indicative of pressure differential across the venturi channel.

4. The multiphase flow meter of claim 1, wherein the statistical characteristic is a local outlier probability for measurements indicative of pressure differential across the venturi channel.

5. The multiphase flow meter of claim 4, wherein the baseline value for the statistical characteristic is an average local outlier probability for the plurality of measurements indicative of the pressure differential across the venturi channel during the first period of time.

6. The multiphase flow meter of claim 1, wherein the multivariable transmitter includes a first sensor adapted to sense a pressure of an inlet to the venturi channel and a second sensor adapted to sense a pressure of a throat in the venturi channel; and
wherein the pressure differential across the venturi channel is the difference between the pressure of the inlet and the pressure of the throat.

7. The multiphase flow meter of claim 6, further comprising:
a first pressure tapping port disposed on an exterior surface of the venturi channel near the inlet, wherein the first sensor is adapted to sense the pressure of the inlet via the first pressure tapping port; and
a second pressure tapping port disposed on the exterior surface of the venturi channel near the throat, wherein the second sensor is adapted to sense the pressure of the throat via the second pressure tapping port.

8. The multiphase flow meter of claim 1, wherein the alert includes a recommendation for cleaning the multiphase flow meter.

9. The multiphase flow meter of claim 1, wherein the controller is further adapted to transmit the alert to a computing device associated with an operator of a wellsite at which the multiphase flow meter is installed.

10. The multiphase flow meter of claim 1, wherein to generate the alert, the controller is further adapted to activate an indicator of the multiphase flow meter.

11. A method for detecting deposit accumulation within a multiphase flow meter, the method comprising:
receiving, from a multivariable transmitter, a plurality of measurements indicative of pressure differential across a venturi channel during a first period of time;
determining, based on the first plurality of measurements, a baseline value for a statistical characteristic associated with pressure differential across the venturi channel;
receiving, from the multivariable transmitter, a new measurement indicative of a pressure differential across the venturi channel after the first period of time;
determining, based in part on the new measurement, a new value for the statistical characteristic associated with pressure differential across the venturi channel;
determining whether a difference between the baseline value and the new value exceeds a threshold; and
in response to determining that the difference between the baseline value and the new value exceeds the threshold, generating an alert that indicates there is deposit accumulation within the multiphase flow meter.

12. The method of claim 11, wherein determining the baseline value for the statistical characteristic associated with pressure differential across the venturi channel includes calculating a moving average for the first plurality of measurements.

13. The method of claim 11, wherein determining the new value for the statistical characteristic associated with pressure differential across the venturi channel includes calculating a new moving average based in part on the new measurement and one or more additional measurements indicative of pressure differential across the venturi channel.

14. The method of claim 11, wherein determining the baseline value for the statistical characteristic associated with pressure differential across the venturi channel includes calculating an average local outlier probability for the first plurality of measurements.

15. The method of claim 11, wherein determining the new value for the statistical characteristic associated with pressure differential across the venturi channel includes calculating a local outlier probability for the new measurement.

16. The method of claim 11, further comprising transmitting the alert to a computing device associated with an operator of a wellsite at which the multiphase flow meter is installed.

17. The method of claim 11, wherein generating the alert comprises activating at least one of a visual indicator or an audible indicator of the multiphase flow meter.

18. The method of claim 11, wherein the alert includes a recommended schedule for servicing the multiphase flow meter.

19. The method of claim 11, wherein the alert includes a recommendation for cleaning the multiphase flow meter.

20. A wellsite, comprising:
an oil well adapted to produce a multiphase stream of fluid;
a manifold coupled to the oil well, the manifold adapted to direct the multiphase stream of fluid to one or more components of the wellsite; and
a multiphase flow meter coupled to the manifold, the multiphase flow meter comprising:
a venturi channel through which the multiphase stream of fluid is enabled to flow;
a multivariable transmitter adapted to measure a pressure differential across the venturi channel; and
a controller coupled to the multivariable transmitter, the controller adapted to:
receive, from the multivariable transmitter, a plurality of measurements indicative of pressure differential across the venturi channel during a first period of time;
determine, based on the first plurality of measurements, a baseline value for a statistical characteristic associated with pressure differential across the venturi channel;
receive, from the multivariable transmitter, a new measurement indicative of a pressure differential across the venturi channel after the first period of time;
determine, based in part on the new measurement, a new value for the statistical characteristic associated with pressure differential across the venturi channel;
determine whether a difference between the baseline value and the new value exceeds a threshold; and
in response to determining that the difference between the baseline value and the new value exceeds the threshold, generate an alert that indicates there is deposit accumulation within the multiphase flow meter.
